(19) United States
(12) Patent Application Publication
(10) Pub. No.: US 2016/0239140 A1
(43) Pub. Date: Aug. 18, 2016

(54) TOUCH SCREEN DISPLAY AND BIDIRECTIONAL DATA TRANSMISSION METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: XI-HUAI HE, Wuhan (CN); CHUN-SHENG CHEN, New Taipei (TW)

(21) Appl. No.: 14/685,119

(22) Filed: Apr. 13, 2015

(30) Foreign Application Priority Data
Feb. 12, 2015 (CN) 201510074484.9

(51) Int. Cl. G06F 3/041; G09G 5/00; G06F 3/044

(52) U.S. Cl. CPC G06F 3/0416; G06F 3/0412; G06F 3/0414; G06F 3/044; G09G 5/006; G09G 2370/12

(57) ABSTRACT

A touch screen display and method for operating the same is provided. A touch screen display includes a display signal transmission interface, a storage module, a display control module, a display panel, a touch panel, and a touch control module. The display signal transmission interface receives display data from the host. The display signal transmission interface includes a display data channel. The display control module displays the received display data on the display panel. The touch panel receives and senses touches on the touch screen. The touch control module generates touch signals and transmits the touch signals to the host through the display data channel enabling bi-directional communication through a single interface.

### CROSS-REFERENCE TO RELATED APPLICATIONS

This application claims priority to Chinese Patent Application No. 201510074484.9, filed on Feb. 12, 2015, the contents of which are incorporated by reference herein.

### FIELD

The subject matter herein relates to data transmission.

### BACKGROUND

Touch screen displays are more and more popular. The touch screen display receives display signals from a host through a digital visual interface, and transmits touch control signals to the host through a universal serial bus interface. Thus, the touch screen display connects to the host through a digital visual cable and a universal serial bus.

### BRIEF DESCRIPTION OF THE DRAWINGS

Implementations of the present technology will now be described, by way of example only, with reference to the attached figures.

FIG. 1 is a block diagram of a touch screen display.

FIG. 2 is a flowchart of a bidirectional data transmission method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

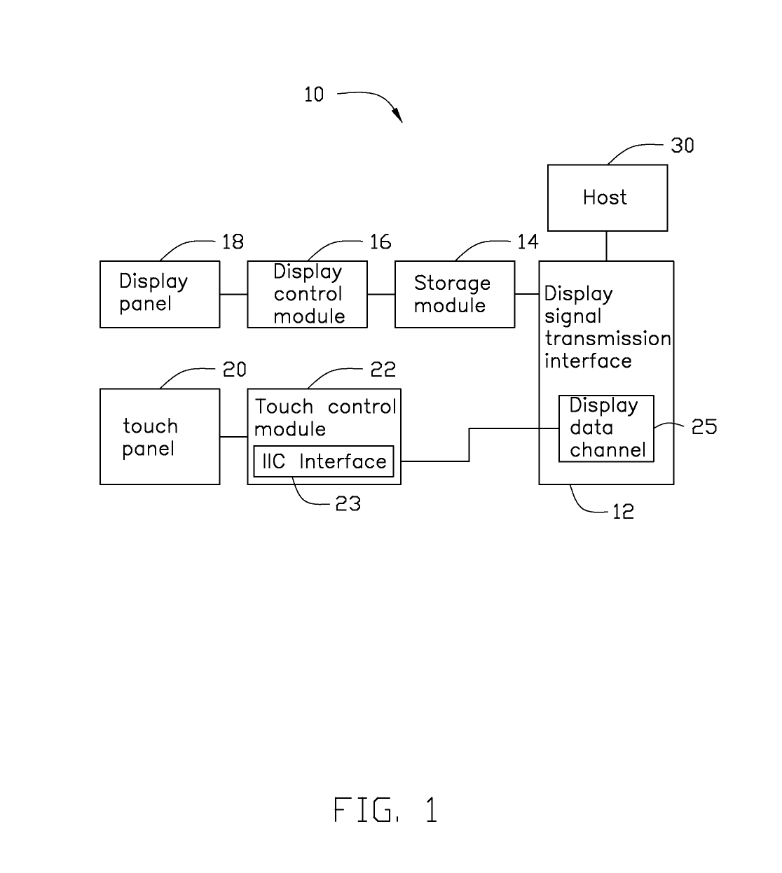

FIG. 1 illustrates a touch screen display 10 including a display signal transmission interface 12, a storage module 14, a display control module 16, a display panel 18, a touch panel 20, and a touch control module 22.

The display signal transmission interface 12 communicates with a host 30. The display signal transmission interface 12 is configured to receive display data transmitted from the host. The host 30 may be a computer or a personal digital assistant. The storage module 14 is configured to store the display data transmitted from the host 30. The storage module 14 may be an electrically-erasable programmable read-only memory. The display control module 16 is configured to display the received display data on the display panel 18.

The touch control module 22 includes an inter-integrated circuit interface (IIC Interface) 23. The display signal transmission interface 12 includes a display data channel (DDC) 25. The display signal transmission interface 12 may be a digital visual interface (DVI) or high definition multimedia interface (HDMI). The inter-integrated circuit interface 23 connects to the display data channel 25 through an inter-integrated circuit bus. The touch panel 20 is configured to receive and sense applied pressure on the touch panel 20 and the touch position of the applied pressure. The touched position includes the coordinate of the applied pressure. The touch panel 20 may be a capacitive touch panel or a resistive touch panel. The touch control module 22 is configured to generate a touch signal according to the touched position and transmit the touch signal to the host 30 through the display data channel 25.

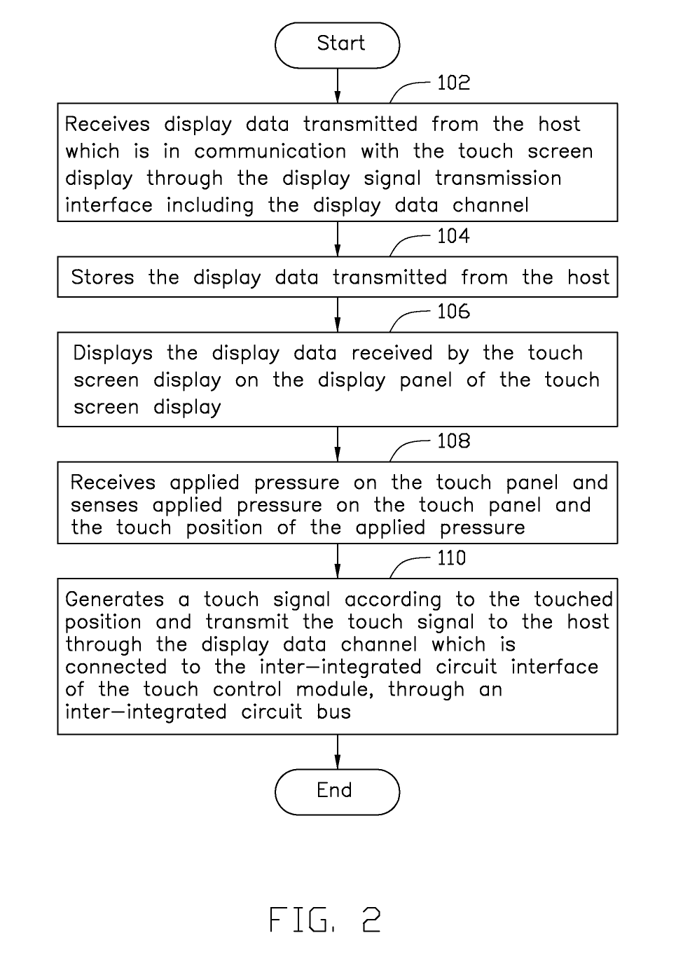

Referring to FIG. 2, a flowchart of a bidirectional data transmission method is presented in accordance with an example embodiment. The example method is provided by way of example, as there are a variety of ways to carry out the method. The method described below can be carried out using the configurations illustrated in FIG. 1, for example, and various elements of these figures are referenced in explaining example method. Each block shown in FIG. 2 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 102.

At block 102, the touch screen display 10 receives display data transmitted from the host 30 which is in communication with the touch screen display 10 through the display signal transmission interface 12 including the display data channel 25.

The host 30 may be a computer or a personal digital assistant. The display signal transmission interface 12 may be a digital visual interface (DVI) or high definition multimedia interface (HDMI).

At block 104, the storage module 14 stores the display data transmitted from the host 30. The storage module 14 may be an electrically-erasable programmable read-only memory.

At block 106, the display control module 16 displays the display data received by the touch screen display 10 on the display panel 18 of the touch screen display 10.

At block 108, the touch panel 20 of the touch screen panel 10 receives applied pressure on the touch panel 20 and senses applied pressure on the touch panel 20 and the touch position of the applied pressure. The touched position includes the coordinates of the applied pressure. The touch panel 20 may be a capacitive touch panel or a resistive touch panel.

At block 110, the touch control module 22 generates a touch signal according to the touched position and transmit the touch signal to the host 30 through the display data channel 25 which is connected to the inter-integrated circuit interface 23 of the touch control module 22, through an inter-integrated circuit bus.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A touch screen display comprising:
a display panel;
a display signal transmission interface communicating with a host and configured to receive display data transmitted from the host, the display signal transmission interface comprising a display data channel;
a display control module configured to display the display data on the display panel;
a touch panel configured to receive applied pressure on the touch panel and sense the touch position of the applied pressure; and
a touch control module configured to generate a touch signal according to the touch position and transmit the touch signal to the host through the display data channel.

2. The touch screen display as claimed in claim 1, wherein the touch control module comprises an inter-integrated circuit interface, the inter-integrated circuit interface connects to the digital visual interface through an inter-integrated circuit bus.

3. The touch screen display as claimed in claim 1, wherein the display signal transmission interface is a digital visual interface.

4. The touch screen display as claimed in claim 1, wherein the display signal transmission interface is a high definition multimedia interface.

5. The touch screen display as claimed in claim 1, wherein the touch position comprises the coordinate of the applied pressure.

6. The touch screen display as claimed in claim 1, further comprises a storage module configured to store the display data transmitted from the host.

7. The touch screen display as claimed in claim 6, wherein the storage module is an electrically-erasable programmable read-only memory.

8. The touch screen display as claimed in claim 1, wherein the touch panel is a capacitive touch panel.

9. A touch screen display comprising:
a display panel;
a display signal transmission interface communicating with a host and comprising a display data channel, display data transmitted from the host to the touch screen display through the display data channel;
a display control module configured to display the display data on the display panel;
a touch panel configured to sense touch position of the applied pressure on the touch panel; and
a touch control module configured to generate a touch signal according to the touch position, the touch control module comprising an inter-integrated circuit interface, the touch control module further configured to transmit the touch signal to the host through an inter-integrated circuit bus connecting the display data channel to the inter-integrated circuit interface.

10. The touch screen display as claimed in claim 9, wherein the display signal transmission interface is a digital visual interface.

11. The touch screen display as claimed in claim 9, wherein the display signal transmission interface is a high definition multimedia interface.

12. The touch screen display as claimed in claim 9, wherein the touch position comprises the coordinate of the applied pressure.

13. The touch screen display as claimed in claim 9, further comprises a storage module configured to store the display data transmitted from the host.

14. The touch screen display as claimed in claim 13, wherein the storage module is an electrically-erasable programmable read-only memory.

15. The touch screen display as claimed in claim 9, wherein the touch panel is a capacitive touch panel.

16. The touch screen display as claimed in claim 9, wherein the host is a personal digital assistant.

17. A bidirectional data transmission method employed in a touch screen display, the bidirectional data transmission method comprising:
receiving display data transmitted from a host communicating with the touch screen display through a display signal transmission interface, the display signal transmission interface comprising a display data channel;
displaying the display date on a display panel of the touch screen display;
receiving applied pressure on the touch panel and sensing the touch position of the applied pressure; and
generating a touch signal according to the touch position and transmitting the touch signal to the host through the display data channel.

18. The bidirectional data transmission method as claimed in claim 17, further comprising:
storing the display data transmitted from the host.

19. The bidirectional data transmission method as claimed in claim 17, wherein the display signal transmission interface is a high definition multimedia interface.

20. The bidirectional data transmission method as claimed in claim 17, wherein the display signal transmission interface is a digital visual interface.
